(19) United States
(12) Patent Application Publication
(10) Pub. No.: US 2025/0158077 A1
(43) Pub. Date: May 15, 2025

(54) BATTERY CELLS INCLUDING MULTI-FUNCTIONAL CURRENT COLLECTORS FOR NICKEL-RICH CATHODE ELECTRODES

(71) Applicant: GM GLOBAL TECHNOLOGY OPERATIONS LLC, Detroit, MI (US)

(72) Inventors: Dewen KONG, Shanghai (CN); Jingyuan Liu, Shanghai (CN); Meiyuan Wu, Shanghai (CN); Yan Wu, Shanghai (CN); Haijing Liu, Shanghai (CN)

(21) Appl. No.: 18/914,372

(22) Filed: Oct. 14, 2024

(30) Foreign Application Priority Data
Nov. 14, 2023 (CN) 2023115149785

(51) Int. Cl. H01M 4/66; H01M 4/02; H01M 4/131

(52) U.S. Cl. CPC H01M 4/667; H01M 4/131; H01M 4/661; H01M 4/663; H01M 4/664; H01M 4/666; H01M 4/668; H01M 4/669; H01M 2004/028

(57) ABSTRACT

A cathode electrode includes a multi-functional cathode current collector including a cathode current collector and a layer including a positive temperature coefficient (PTC) material arranged adjacent to the cathode current collector. A cathode active material layer is arranged on the multi-functional cathode current collector and includes a cathode active material including nickel.

### CROSS-REFERENCE TO RELATED APPLICATIONS

This application claims the benefit of Chinese Patent Application No. 202311514978.5 filed on Nov. 14, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to cathode electrodes for battery cells, and more particularly to multi-functional cathode current collectors for nickel-rich cathode electrodes.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A cathode electrode includes a multi-functional cathode current collector including a cathode current collector and a layer including a positive temperature coefficient (PTC) material arranged adjacent to the cathode current collector. A cathode active material layer is arranged on the multi-functional cathode current collector and includes a cathode active material including nickel.

In other features, the cathode active material comprises a rock salt layered oxide including nickel. The cathode active material is selected from a group consisting of LiNiₓMn_{y}Co_{1-x-y}O₂, LiNₓCo_{y}Al_{1-x-y}O₂, LiNiₓCo_{y}Mn_{z}Al_{1-x-y-z}O₂, LiNiₓMn_{y}Al_{1-x-y}O₂, LiNiₓMn₁₋ₓO₂, and LiNiO₂, where x, y, and z are in a range from 0 to 1.

In other features, the cathode current collector is made of at least one of aluminum and stainless steel. A thickness of the multi-functional cathode current collector is in a range from 4 μm to 30 μm. The layer includes a PTC layer including the PTC material and a polymer arranged on the cathode current collector and a conductive layer arranged on the PTC layer and including a conductive additive and a hot adhesive polymer.

In other features, the layer includes a conductive layer including a conductive additive and a polymer arranged on the cathode current collector and a PTC layer arranged on the conductive layer and including the PTC material and a hot adhesive polymer.

In other features, the layer further includes a hot adhesive polymer. The layer further includes a conductive additive and a hot adhesive polymer. The conductive additive is selected from a group consisting of a carbon-based conductive additive, an oxide-based conductive additive, a carbide, and a silicide. The cathode active material comprises 70 to 99 wt % of the cathode active material layer, a conductive additive comprises 0.5 wt % to 20 wt % of the cathode active material layer, and a binder comprises 0.5 wt % to 10 wt % of the cathode active material layer.

In other features, the PTC material is doped with one or more materials selected from a group consisting of lanthanum (La), cesium (Ce), tin (Sb), yttrium (Y), tungsten (W), titanium (Ti), tantalum (Ta), niobium (Nb), cobalt (Co), chlorine (CI), iodine (I), and bromine (Br). The PTC material comprises at least one of BaTIO₃ and a V₂O₅-based PTC material.

In other features, a room temperature (RT) resistance of the PTC material is less than 50 ohm-meter, and a Curie temperature of the PTC material is in a range from 80° C. to 200° C. A ratio of resistance of the PTC material at the Curie temperature divided by resistance of the PTC material at room temperature is greater than 100.

A cathode electrode includes a multi-functional cathode current collector including a cathode current collector made of at least one of aluminum and stainless steel and a layer including a positive temperature coefficient (PTC) material and a hot adhesive polymer arranged adjacent to the cathode current collector. A cathode active material layer is arranged on the multi-functional cathode current collector and includes a cathode active material including a rock salt layered oxide including nickel.

In other features, the layer includes a PTC layer including the PTC material and a polymer and a conductive layer arranged on the PTC layer and including a conductive additive and a hot adhesive polymer. The layer includes a conductive layer including a conductive additive and a polymer and a PTC layer arranged on the conductive layer and including the PTC material and a hot adhesive polymer. The layer further includes a conductive additive.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes with Ni-rich cathode active material and multi-functional cathode current collectors, anode electrodes, and separators arranged in a battery cell enclosure according to the present disclosure;

FIGS. 2 to 5 are side cross sectional views of examples of multi-functional cathode current collectors according to the present disclosure;

FIG. 6 is a graph illustrating resistance as a function of temperature for a positive temperature coefficient (PTC) material of the multi-functional cathode current collectors according to the present disclosure;

FIG. 7 is a flowchart of a method for manufacturing the multi-functional cathode current collector and a cathode electrode including the multi-functional cathode current collector according to the present disclosure; and

FIGS. 8 to 10 are graphs illustrating voltage as a function of capacity for a conventional battery cell and a battery cell including the cathode electrodes with the multi-functional cathode current collectors according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

As described above, battery cells include cathode electrodes, anode electrodes, and separators arranged in an enclosure. The cathode electrodes include a cathode active material layer (including cathode active material) arranged on a cathode current collector. In some examples, the cathode active material layer includes nickel-rich (Ni-rich) cathode active material. Ni-rich cathode active materials such as NCMA, NCA and NMC811 are thermally unstable since they decompose below 300° C. and generate molecular oxygen (O₂). When O₂ is released, it reacts with flammable cell contents and increases the likelihood of thermal events such as thermal runaway.

The present disclosure relates to cathode electrodes including multi-functional cathode current collectors and Ni-rich cathode active material. The multi-functional cathode current collector includes a conductive filler (e.g., carbon black), a polymer, a hot adhesive polymer (e.g., PE-EVA), and/or a positive temperature coefficient (PTC) material (e.g., BaTiO₃). In some examples, the cathode current collector is used for a cathode electrode including a cathode active material comprising a Ni-rich cathode material and polytetrafluoroethylene (PTFE) binder. The multi-functional current collector prevents thermal runaway events by increasing the resistance of the cathode current collector by a factor of around 5×10⁵ at 100° C. as compared to the resistance of the cathode current collector at a lower temperature such as 36° C. The increased resistance blocks an electron flow path of the cathode active material layer to the cathode current collector to enhance thermal stability without sacrificing electrochemical performance at lower temperatures (e.g., normal operating temperature).

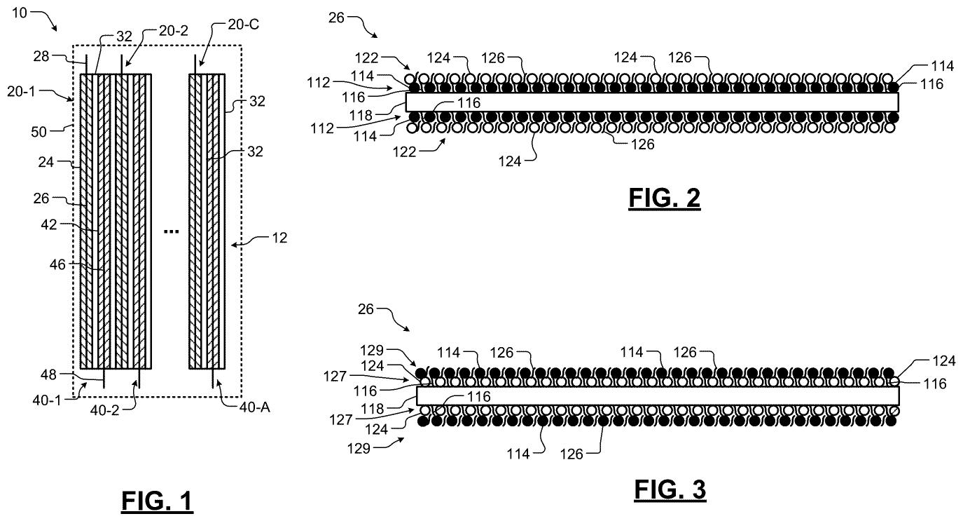

Referring now to FIG. 1, a battery cell 10 includes C cathode electrodes 20, A anode electrodes 40, and S separators 32 arranged in a predetermined sequence in a battery cell stack 12 located in an enclosure 50 that may include electrolyte, where C, S and A are integers greater than zero. The C cathode electrodes 20-1, 20-2, . . . , and 20-C include cathode active material layers 24 arranged on one or both sides of a multi-functional cathode current collector 26. The cathode active material layers 24 include Ni-rich cathode active material.

The A anode electrodes 40-1, 40-2, . . . , and 40-A include anode active material layers 42 arranged on one or both sides of the anode current collectors 46. In some examples, the anode active material layers 42 and/or the cathode active material layers 24 are free-standing electrodes that are arranged adjacent to (or attached to) the multi-functional cathode current collectors 26 and/or the anode current collectors 46, respectively. In some examples, the anode active material layers 42 and/or the cathode active material layers 24 comprise coatings or freestanding film including one or more active materials, one or more conductive fillers/additives, and/or one or more binder materials that are applied to the current collectors.

In some examples, the multi-functional cathode current collector 26 and the anode current collectors 46 comprise metal foil, metal mesh, perforated metal, 3 dimensional (3D) metal foam, and/or expanded metal. In some examples, the anode current collectors 46 are made of one or more materials selected from a group consisting of copper, stainless steel, brass, bronze, zinc, aluminum, and/or alloys thereof. In some examples, the multi-functional cathode current collectors 26 are made of one or more materials selected from a group consisting of stainless steel and aluminum. In some examples, the cathode current collector 26 has a thickness in a range from 4 μm to 30 μm. In some examples, the cathode current collector 26 has a thickness in a range from 6 μm to 20 μm. External tabs 28 and 48 are connected to the current collectors of the cathode electrodes and anode electrodes, respectively, and can be arranged on the same or opposite sides of the battery cell stack 12. The external tabs 28 and 48 are connected to terminals of the battery cells.

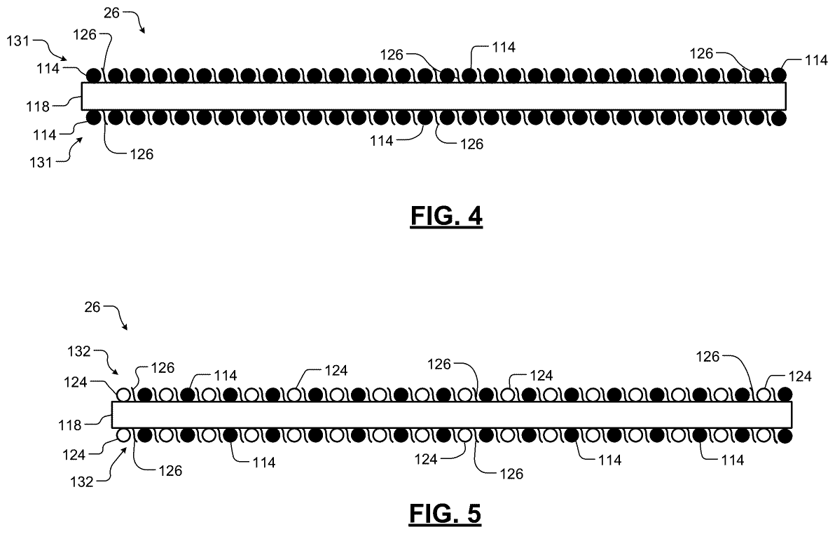

Referring now to FIGS. 2 to 5, various examples of the multi-functional cathode current collector 26 are shown. In FIG. 2, the multi-functional cathode current collector 26 includes a positive temperature coefficient (PTC) layer 112 including a PTC material 114 and polymer 116 (e.g., polyacrylic acid (PAA) or polyethylene—ethylene vinyl acetate (PE-EVA)) arranged on one or both sides of a cathode current collector 118. The cathode current collector 118 is made of one or more materials selected from a group consisting of stainless steel, aluminum, and/or other suitable materials. A conductive layer 122 is arranged on the PTC layer 112 and includes a conductive filler 124 and a hot adhesive polymer 126 (e.g., PE-EVA).

In FIG. 3, a conductive layer 127 including the conductive filler 124 and the polymer 116 is arranged on one or both surfaces of the cathode current collector 118. A PTC layer 129 including the PTC material 114 and the hot adhesive polymer 126 is arranged on one or both surfaces of the conductive layer 127.

In FIG. 4, a single layer is used and the conductive filler 124 is omitted. A PTC layer 131 including the PTC material 114 and the hot adhesive polymer 126 is arranged on one or both surfaces of the cathode current collector 118.

In FIG. 5, a hybrid layer 132 is arranged on one or both surfaces of the cathode current collector 118. The hybrid layer 132 includes the PTC material 114, the conductive filler 124, and the hot adhesive polymer 126 (e.g., PE-EVA). The hot adhesive polymer provides a robust mechanical connection between the cathode current collector and the cathode active material layer.

In the cathode electrodes in FIGS. 2 to 5, as the operating temperature increases to a predetermined temperature (e.g., 150° C.), the resistance of the PTC layer significantly increases. The increase in resistance reduces current flow and increases thermal stability.

In other examples, the cathode electrodes are manufactured using wet coating and the hot adhesive polymer (used to provide adhesion to the free-standing film) is omitted. In other words, the outermost layer of the multi-functional cathode current collector does not include the hot adhesive polymer and the cathode active material layer is cast on the cathode current collector. For example, a cathode active material (e.g., NCMA), a binder (e.g., polyvinylidene difluoride (PVDF)), and an optional conductive additive are mixed with a solvent, cast onto the multi-functional cathode current collector, and dried.

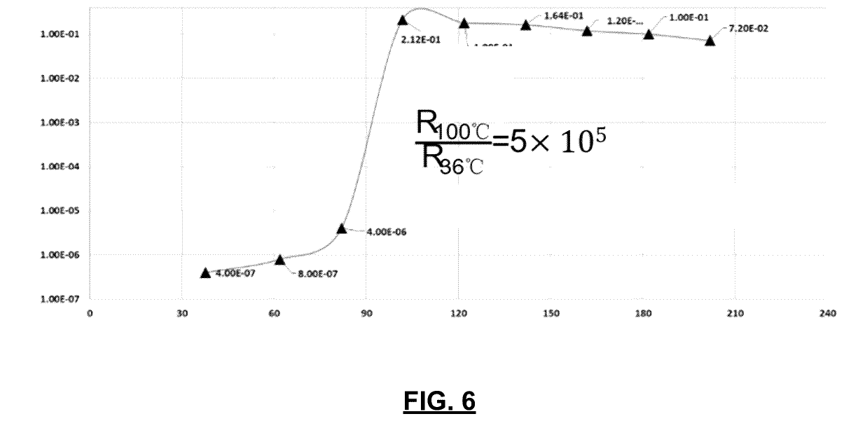

Referring now to FIG. 6, a graph illustrates resistance as a function of temperature for a positive temperature coefficient material such as barium titanate (BaTiO₃). As the temperature increases from a typical operating temperature (e.g., 36° C.) to a higher temperature such as 100° C., the resistance increases by a magnitude of approximately 10⁵.

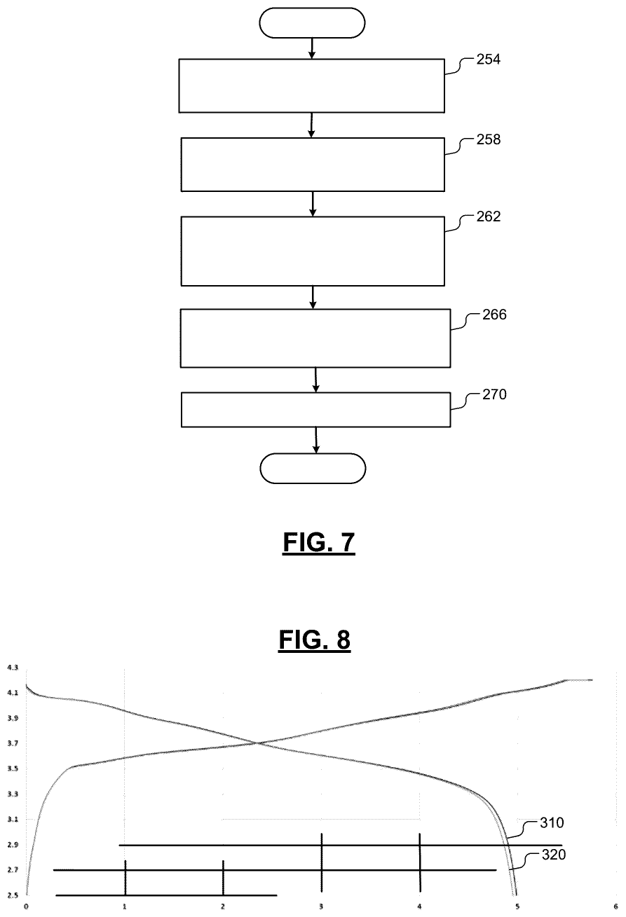

Referring now to FIG. 7, a flowchart of a method for manufacturing the multi-functional cathode current collector and a cathode electrode including the multi-functional cathode current collector of FIG. 5 is shown. At 254, hot adhesive polymer, conductive additive, and a PTC material are mixed to create a slurry. At 258, the slurry is cast or printed (e.g., intaglio printed) onto a cathode current collector and dried. At 262, the process is optionally repeated on an opposite side of the cathode current collector. At 266, a free-standing or cast cathode active material layer is arranged or cast on one or both sides of the multi-functional cathode current collector. At 270, the layers are optionally pressed and/or heated. In some examples, the layers are heated above a melting temperature of the hot adhesive polymer. The hot adhesive polymer provides robust adhesive force between the current collector and the free-standing film (including the Ni-rich cathode active material layer).

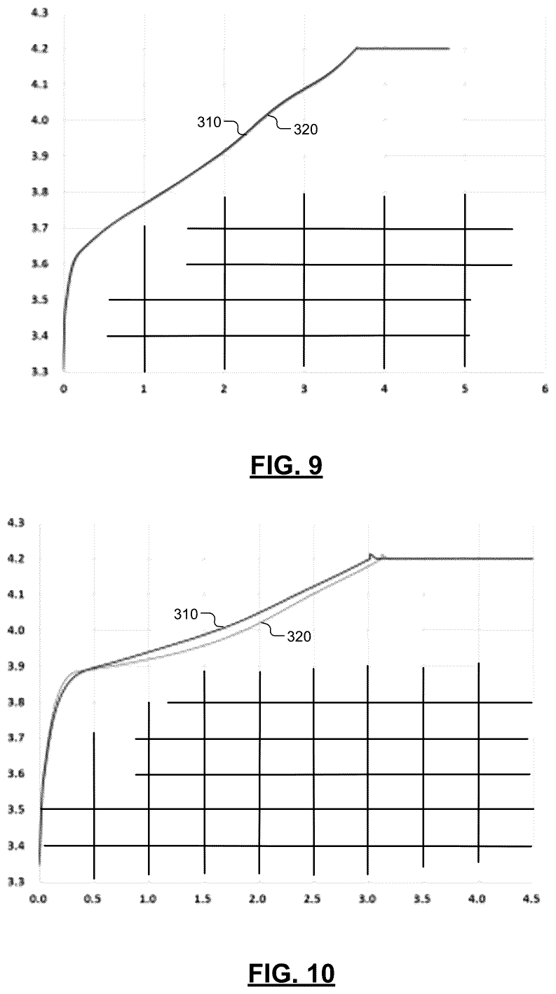

Referring now to FIGS. 8 to 10, graphs illustrate voltage as a function of capacity for a conventional battery cell and a battery cell including a cathode electrode with the multi-functional cathode current collector. In general, the conventional battery cell and the battery cell including the cathode electrode with the multi-functional cathode current collector have similar performance at normal operating temperatures. However, the cathode electrode with the multi-functional cathode current collector has the additional benefit of thermal runaway protection. When operating temperature increases, the resistance of the path to the cathode current collector increases to reduce current flow.

In FIG. 8, the conventional battery cell (identified at 310) and the battery cell including the cathode electrode with the multi-functional cathode current collector (identified at 320) have similar 1^{st} cycle performance (e.g., NCMA electrode in half coin cell at C/20 and 25° C.). The cathode active material layer comprises NCMA as the cathode active material, Super P as the conductive additive, and PTFE as the binder at a mass ratio of 96:2:2, respectively. The charging was performed using constant current constant voltage (CCCV) charging at C/20 with a C/100 taper. Discharge was at C/20 and the voltage range is from 2.7V to 4.2V.

The cathode electrodes delivered approximately the same performance. The conventional battery cell 310 had a charge capacity loading of 5.76 mAh/cm², a discharge capacity loading of 4.99 mAh/cm², and a columbic efficiency of 86.6%. The battery cell including the cathode electrode with the multi-functional cathode current collector had a charge capacity loading of 5.71 mAh/cm², a discharge capacity loading of 4.95 mAh/cm², and a columbic efficiency of 86.7%.

In FIGS. 9 and 10, charge rate testing is shown for the conventional battery cell at 310 and the battery cell including the cathode electrode with the multi-functional cathode current collector at 320 at 1 C and 25° C. and 2 C at 25° C., respectively. The cathode active material layer comprises NCMA as the cathode active material, SuperP as the conductive additive, and PTFE as the binder at a mass ratio of 96:2:2, respectively. The charging was performed using constant current constant voltage (CCCV) charging at 1 C with a C/20 taper. The voltage range is from 2.7V to 4.2V. The conventional cathodes and the cathode electrodes with the multi-functional cathode current collectors delivered comparable charge rate performance.

In some examples such as those in FIGS. 2 and 3, the PTC layer includes polymer in a range from 3 wt % to 40 wt. % and PTC material in a range from 10 to 97 wt. %. In other examples, the PTC layer includes polymer in a range from 5 wt % to 15 wt. % and PTC material in a range from 40 to 85 wt. %. The polymer comprises a hot adhesive polymer (e.g., such as polyacrylic acid (PAA), styrene butadiene rubber (SBR), PAA-IEA). In some examples, the PTC layer has a thickness in a range from 0.5 μm to 10 μm. In some examples, the PTC layer has a thickness in a range from 1.0 μm to 3 μm.

In some examples such as those in FIG. 4, the hybrid layer includes hot adhesive polymer in a range from 10 wt % to 40 wt. %, PTC material in a range from 5 wt % to 30 wt. %, and conductive additive in a range from 30 to 70 wt %. In other examples, the hybrid layer includes hot adhesive polymer in a range from 20 wt % to 30 wt. %, PTC material in a range from 10 wt % to 20 wt. %, and conductive additive in a range from 40 to 60 wt %. In some examples, the hybrid layer has a thickness in a range from 0.5 μm to 10 μm. In some examples, the hybrid layer has a thickness in a range from 1.0 μm to 3 μm.

In some examples, the conductive additive is selected from a group consisting of a carbon-based conductive additive, an oxide-based conductive additive, a carbide, and a silicide. Examples of carbon-based conductive additive include carbon black, graphite, graphene, graphene oxide, Super P, acetylene black, carbon nanofiber, carbon nanotubes, and other electronically conductive additives. Examples of oxides include simple oxides and superconducting oxides. Examples of simple oxides include ruthenium oxide RuO₂, tin oxide (SnO₂), zinc oxide (ZnO), and germanium oxide (Ge₂O₃). Examples of superconducting oxides include yttrium barium copper oxide (YBCO or YBa₂Cu₃O₇) and La_{0.75}Ca_{0.25}MnO₃. An example of a carbide includes silicon carbide (SiC₂). An example of a silicide includes molybdenum disilicide (MoSi₂).

In some examples, the polymer is selected from a group consisting of polyurethane (PU), polyamide (PA), polyethylene (PE), PE-(ethylene vinyl acetate) EVA, polyacrylic acid (PAA), polyvinyl chloride (PVC), and combinations thereof. In some examples, the polymer comprises a hot adhesive polymer.

In some examples, the PTC material is selected from a group consisting of an inorganic PTC material and an organic PTC material. Examples of inorganic PTC material include BaTIO₃ and a V₂O₅-based PTC material. In some examples, the PTC material is doped to alter a Curie temperature of the PTC material. In some examples, the dopant comprises one or more materials selected from a group consisting of (lanthanum (La), cesium (Ce), tin (Sb), yttrium (Y), tungsten (W), titanium (Ti), tantalum (Ta), niobium (Nb), cobalt (Co), chlorine (CI), iodine (I), and/or bromine (Br)). In some examples, an oxide additive such as SiO₂ or Al₂O₃ is added.

In some examples, a Curie temperature of the PTC material is in a range from 80° C. to 200° C. In some examples, a Curie temperature of the PTC material is in a range from 90° C. to 120° C. In some examples, room temperature (RT) resistance of the PTC material is less than 50 ohm-meter (ohm·m). In some examples, room temperature (RT) resistance of the PTC material is less than 10 ohm·m. In some examples, a ratio of resistance at the Curie temperature divided by resistance at room temperature is greater than 100. In some examples, a ratio of resistance at the Curie temperature divided by resistance at room temperature is greater than 1000.

In some examples, the cathode active material comprises 70 to 99 wt % % of the cathode active material layer, the conductive additive comprises 0.5 wt % to 20 wt % of the cathode active material layer, and the binder comprises 0.5 wt % to 10 wt % of the cathode active material layer. In some examples, the cathode active material includes Ni-rich rock salt layered oxides. Examples of Ni-rich rock salt layered oxides include LiNiₓMn_{y}Co_{1-x-y}O₂ (NMC) 811, LiNₓCo_{y}Al_{1-x-y}O₂ (NCA), LiNiₓCo_{y}Mn_{z}Al_{1-x-y-z}O₂ (NCMA), LiNiₓMn_{y}Al_{1-x-y}O₂ (NMA), LiNiₓMn₁₋ₓO₂ (NM), and LiNiO₂ (LNO).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A cathode electrode comprising:
a multi-functional cathode current collector including:
a cathode current collector; and
a layer including a positive temperature coefficient (PTC) material arranged adjacent to the cathode current collector; and
a cathode active material layer arranged on the multi-functional cathode current collector and comprising a cathode active material including nickel.

2. The cathode electrode of claim 1, wherein the cathode active material comprises a rock salt layered oxide including nickel.

3. The cathode electrode of claim 1, wherein the cathode active material is selected from a group consisting of LiNixMnyCo1-x-yO2, LiNxCoyAl1-x-yO2, LiNixCoyMnzAl1-x-y-zO2, LiNixMnyAl1-x-yO2, LiNixMn1-xO2, and LiNiO2, where x, y, and z are in a range from 0 to 1.

4. The cathode electrode of claim 1, wherein the cathode current collector is made of at least one of aluminum and stainless steel.

5. The cathode electrode of claim 4, wherein a thickness of the multi-functional cathode current collector is in a range from 4 μm to 30 μm.

6. The cathode electrode of claim 1, wherein the layer includes:
a PTC layer including the PTC material and a polymer arranged on the cathode current collector; and
a conductive layer arranged on the PTC layer and including a conductive additive and a hot adhesive polymer.

7. The cathode electrode of claim 1, wherein the layer includes:
a conductive layer including a conductive additive and a polymer arranged on the cathode current collector; and
a PTC layer arranged on the conductive layer and including the PTC material and a hot adhesive polymer.

8. The cathode electrode of claim 1, wherein the layer further includes a hot adhesive polymer.

9. The cathode electrode of claim 1, wherein the layer further includes a conductive additive and a hot adhesive polymer.

10. The cathode electrode of claim 6, wherein the conductive additive is selected from a group consisting of a carbon-based conductive additive, an oxide-based conductive additive, a carbide, and a silicide.

11. The cathode electrode of claim 1, wherein the cathode active material comprises 70 to 99 wt % of the cathode active material layer, a conductive additive comprises 0.5 wt % to 20 wt % of the cathode active material layer, and a binder comprises 0.5 wt % to 10 wt % of the cathode active material layer.

12. The cathode electrode of claim 11, wherein the PTC material is doped with one or more materials selected from a group consisting of lanthanum (La), cesium (Ce), tin (Sb), yttrium (Y), tungsten (W), titanium (Ti), tantalum (Ta), niobium (Nb), cobalt (Co), chlorine (Cl), iodine (I), and bromine (Br).

13. The cathode electrode of claim 1, wherein the PTC material comprises at least one of BaTIO₃ and a V₂O₅-based PTC material.

14. The cathode electrode of claim 1, wherein:
a room temperature (RT) resistance of the PTC material is less than 50 ohm-meter, and
a Curie temperature of the PTC material is in a range from 80° C. to 200° C.

15. The cathode electrode of claim 14, wherein a ratio of resistance of the PTC material at the Curie temperature divided by resistance of the PTC material at room temperature is greater than 100.

16. A cathode electrode comprising:
a multi-functional cathode current collector including:
a cathode current collector made of at least one of aluminum and stainless steel; and
a layer including a positive temperature coefficient (PTC) material and a hot adhesive polymer arranged adjacent to the cathode current collector; and
a cathode active material layer arranged on the multi-functional cathode current collector and comprising a cathode active material including a rock salt layered oxide including nickel.

17. The cathode electrode of claim 16, wherein the layer includes:
a PTC layer including the PTC material and a polymer; and
a conductive layer arranged on the PTC layer and including a conductive additive and a hot adhesive polymer.

18. The cathode electrode of claim 16, wherein the layer includes:
a conductive layer including a conductive additive and a polymer; and
a PTC layer arranged on the conductive layer and including the PTC material and a hot adhesive polymer.

19. The cathode electrode of claim 16, wherein the layer further includes a conductive additive.
